(19) United States
(12) Patent Application Publication
(10) Pub. No.: US 2008/0020144 A1
(43) Pub. Date: Jan. 24, 2008

(54) Coating system for metal bands and method for producing metal bands which are coated on one side

(76) Inventors: Leszek Poletek, Ulm (DE); Hermann Sturm, Bellenberg (DE)

Correspondence Address: FLYNN THIEL BOUTELL & TANIS, P.C., 2026 RAMBLING ROAD, KALAMAZOO, MI, 49008-1631, US

(21) Appl. No.: 11/789,908

(22) Filed: Apr. 25, 2007

(30) Foreign Application Priority Data
May 18, 2006 (DE) 10 2006 023283.6

(51) Int. Cl. B05D 1/28

(52) U.S. Cl. 427/428.2; 118/258

(57) ABSTRACT

The invention relates to a coating system for metal bands, comprising a melt bath with liquid coating material, a coating roller, and a band guide for the metal band which runs over the coating roller, wherein the coating roller only partially immerses in the melt bath, and this roller comprises a material which is not wettable by the liquid coating material.

A further aspect of the invention relates to a method for producing metal bands which are coated on one side by means of the coating system according to the invention.

The present invention relates to a coating system for metal bands, and a method for producing metal bands which are coated on one side by means of the coating system.

It is known to produce metal bands which are tinned on one side by means of fire tinning or by means of galvanic tinning.

A method for producing steel bands which are coated on one side is known from patent specification DE 27 12 003 C2. The steel bands are provided from a melt supply with a coating of zinc, a zinc alloy, aluminum or an aluminum alloy, for producing corrosion-resistant surfaces. For coating, the metal band is not immersed in the melt bath, but guided along over the surface of the melt. In doing so, the band is brought into a position directly over the surface of the melt in which the surface tension and the wetting properties of the molten coating metal bring about the forming of a meniscus on the surface of the melt bath. By means of the meniscus, the band is in direct contact with the melt bath and is continuously provided with a coating only on one side of the band.

A method and a device for continuous coating of one side of a steel band with a molten metal is known from patent specification DE 29 52 573 C2. By means of guide rollers, the band is horizontally guided over a melt bath, from which an ascending flow of melt is directed to the underside of the band by means of an application device. The application device includes a pump by which material is extracted from the melt bath via a line, which material is guided up to an outlet opening which is close to the underside of the band. By means of the emergent melt, a metal coating is produced on the underside of the band, and, in doing so, prevents molten metal being able to flow onto the upper side of the band. The outlet opening has an overflow opening to one side, by means of which surplus melt can escape, which is fed again to the melt bath.

The object of the invention is based on developing a coating system for metal bands which are coated on one side.

With regard to a coating system, the invention is described by the features of Claim 1, and with regard to a method for producing metal bands, is described by the features of Claim 6. The further related claims relate to advantageous forms and developments of the invention.

The invention comprises a coating system for metal bands, comprising a melt bath with liquid coating material, a coating roller, and a band guide for the metal band which runs over the coating roller, wherein the coating roller only partially immerses in the melt bath, and at least the surface of the coating roller comprises a material which is not wettable by the liquid coating material.

The invention starts in this case from the consideration that the metal band which is to be coated is guided over the coating roller in a tight-fitting manner. As a metal coating, for example liquid tin or a tin alloy is especially applied to a metal band of copper or a copper alloy. Surplus tin is doctored for establishing the desired coating thickness.

The metal band which is to be coated is guided around the coating roller and tensioned by the required band tension so that it is ensured that no liquid coating material reaches the rear side of the metal band.

In the case of the one-sided tinning by a coating roller which immerses in the melt bath, it is especially important that no coating material adheres to the surface of the roller. For this purpose, at least the surface of the coating roller comprises a material which is not wetted by the coating material. Either surfaces which deflect the molten metal, or even solid material, are suitable. In connection with coating materials which contain tin, gray cast iron or ceramics especially come into consideration, for example aluminum oxide, silicon nitride or graphite.

The special advantage is that a one-sided coating on metal bands can be produced reliably and at little cost. The metal band, in the regions in which the coating is applied, comes into contact by its rear side with the coating roller, as a result of which further provisions for protection of the rear side of the band are no longer necessary. Depending upon process execution, the surplus coating material is purposefully removed in order to establish the desired coating thicknesses. The coating system according to the invention for producing surface coatings which contain tin on band material of copper or copper alloys is especially advantageous.

In the simplest form, the coating roller has a uniform cylindrical shape over the whole length. With a cylindrical shape, the band material lies full-faced on the surface of the roller.

In an advantageous development of the invention, the surface of the coating roller can be formed concavely or conically towards the middle of the roller. With a concave curvature, the edge regions of the metal band are pressed more firmly onto the roller surface, as a result of which an additional sealing on the band edges against the melt is achieved. A conical shape, in which the radius of the coating roller continuously reduces towards the middle as seen from the two ends, acts in a similar way. With a special shape of the concave coating roller, basically only those regions upon which the coating roller comes into contact with the band edges have a curvature of the roller surface. In other words, the surface of the coating roller is slightly convexly curved only in the region of the bearing band edges, and in the further progression in the direction of the middle of the roller has a cylindrical shape. The coating roller, therefore, has a somewhat smaller radius towards the middle of the roller than the outer edge of the roller. By means of this special development of the roller surface, there results on the respective edges of the metal band a slight curvature in relation to a band surface which otherwise lies flat, which curvature, under tensile stress, seals the edge-side regions especially well in relation to the melt. A penetrating of liquid coating material into a gap which is formed between the coating roller and the band material can be reliably prevented in this way.

In a preferred development, the pivot of the coating roller which immerses in the melt bath can be located above the surface of the melt bath. As a result of this, the coating roller is only partially brought into contact with the melt.

A doctoring unit can be advantageously located downstream of the coating roller, as seen in the running direction of the band. In this case, the doctoring unit can be a doctoring element and/or a blast nozzle. Through the coating process, the coating material is customarily applied in excess onto the metal band which is to be coated. In the case of metal coatings which contain tin, the desired final thicknesses of the coating especially often are appreciably below the thickness of the originally applied material. Surplus tin, therefore, is doctored over a plurality of stages and the coating thickness is purposefully established.

At least the coating roller can be advantageously located in a closed housing with protective gas in order to avoid an oxide formation, especially on the side of the band which is not coated.

A further aspect of the invention, with regard to the method for producing metal bands which are coated on one side by means of the coating system according to the invention, includes the following steps:
a metal band is guided over a coating roller,
a coating is applied on the metal band, on the surface which lies opposite the coating roller, and
the surplus coating material is removed down to the desired coating thickness, before or after the metal band is lifted from the surface of the coating roller.

Further advantages and developments of the invention are explained in detail with reference to the schematic drawings.

In the drawings, in this case:

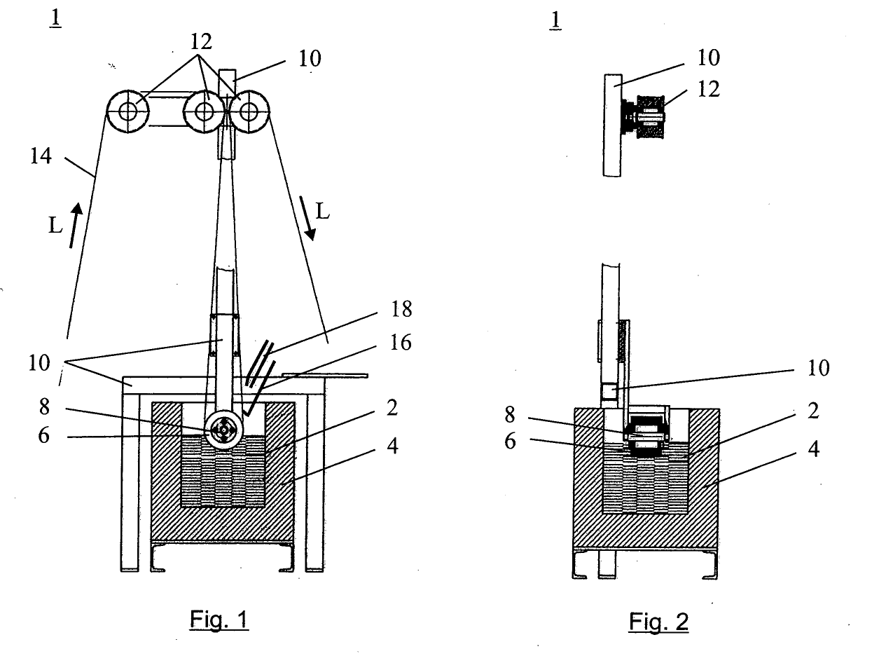

FIG. 1 shows a front view of a coating system with melt bath, and

FIG. 2 shows a side view of the coating system according to FIG. 1.

Parts which correspond to each other in all the figures are provided with the same designations.

A coating system 1 with a tin bath 2 is shown in FIG. 1, which bath is located in a heated melt tank with insulation 4. The one-sided tinning is carried out by a coating roller 6 which immerses in the tin bath 2. This coating roller comprises ceramic solid material in which no coating material adheres to the surface of the coating roller 2. FIG. 2 shows a side view of the coating system 1.

The coating roller 6 only partially immerses in the tin bath 2. At the same time, the metal band 14, which is to be coated on one side, is guided through the tin bath 2 by means of guide rollers 12, as a band guide with the necessary band tension, in a manner in which the band fits tightly against the coating roller 6 in order to avoid an unwanted penetrating of the molten metal between metal band 14 and coating roller 6. The individual process units are mounted on a supporting framework 10. The running direction L of the metal band 14 is identified in each case by means of an arrow.

In the coating system 1 which is shown in FIGS. 1 and 2, the roller pivot 8 of the coating roller 6 does not immerse in the tin bath 2. As a result of this, the coating roller 6 is only partially brought into contact with the melt. Since with metal coatings which contain tin the desired final thicknesses of the coating are appreciably below the thickness of the originally applied material, surplus tin is removed over two stages. For this purpose, by means of a doctoring unit 16 and a blast nozzle 18 which are located downstream of the melt bath 2, as seen in the running direction L of the band, the coating thickness is established in the coated metal band 14.

There can be further process units added upstream, as for example a chemical or mechanical cleaning unit of the band surface before the coating. In the same way, further process units can also follow downstream, as for example a furnace for temperature treatment of the applied metal coating.

### LIST OF DESIGNATIONS

1 Coating system
2 Melt bath/tin bath
4 Melt tank with insulation
6 Coating roller
8 Roller pivot
10 Supporting framework
12 Band guide/guide rollers
14 Metal band
16 Doctoring element
18 Blast nozzle
L Running direction

1. Coating system for metal bands, comprising a melt bath with liquid coating material, a coating roller and a band guide for the metal band which runs over the coating roller, wherein
the coating roller only partially immerses in the melt bath, and at least the surface of the coating roller comprises a material which is not wettable by the liquid coating material.

2. Coating system according to claim 1, wherein the surface of the coating roller is concavely or conically formed towards the middle of the roller.

3. Coating system according to claim 1, wherein the pivot of the coating roller which immerses in the melt bath is located above the surface of the melt bath.

4. Coating system according to claim 1, wherein a doctoring element is located downstream of the coating roller, as seen in the running direction of the band.

5. Coating system according to claim 1, wherein at least the coating roller is located in a closed housing with protective gas.

6. Method for producing metal bands which are coated on one side by means of a coating system, comprising the steps:
a metal band (14) is guided over a coating roller,
a coating is applied on the metal band on a surface which lies opposite the coating roller, and
surplus coating material is removed down to the desired coating thickness, before or after the metal band is lifted from the surface of the coating roller.

7. Coating system according to claim 4, further comprising a blast nozzle located downstream of the coating roller, as seen in the running direction of the band.

8. Coating system according to claim 1, further comprising a blast nozzle located downstream of the coating roller, as seen in the running direction of the band.
